(19) United States
(12) Patent Application Publication
(10) Pub. No.: US 2013/0063398 A1
(43) Pub. Date: Mar. 14, 2013

(54) OPTICAL TOUCH DISPLAY PANEL AND TOUCH SENSING METHOD THEREOF

(71) Applicants: Chien-Chuan Ko, Changhua County (TW); Chao-Hui Wu, Kaohsiung County (TW)

(72) Inventors: Chien-Chuan Ko, Changhua County (TW); Chao-Hui Wu, Kaohsiung County (TW)

(73) Assignee: HANNSTAR DISPLAY CORPORATION, New Taipei City (TW)

(21) Appl. No.: 13/329,344

(22) Filed: Dec. 19, 2011

(30) Foreign Application Priority Data
Sep. 8, 2011 (TW) 100132446

(51) Int. Cl. G06F 3/042

(52) U.S. Cl. 345/175

(57) ABSTRACT

An optical touch display panel and a touch sensing method thereof are provided. The optical touch display panel includes a scan line, a readout line, and a photosensing unit. The photosensing unit is activated in response to a scan signal received by the scan line, and reacts a photosensing current on the readout line according to the scan signal and a reference level.

### CROSS-REFERENCE TO RELATED APPLICATION

This application claims the priority benefit of Taiwan application serial no. 100132446, filed on Sep. 8, 2011. The entirety of the above-mentioned patent application is hereby incorporated by reference herein and made a part of this specification.

### BACKGROUND OF THE INVENTION

1. Field of the Invention

The present invention relates to an optical touch sensing technology, and more particularly to an optical touch display panel and a touch sensing method thereof, which are capable of increasing correctness of interpreting a touch position.

2. Description of Related Art

The integration of a touch panel in a liquid crystal display (LCD) may enhance the convenience and quick input of a user and also may provide an interactive access function. Therefore, the touch panel has gradually applied in some portable electronic devices, such as mobile phones, personal digital assistants (PDAs) or laptop computers.

In a conventional touch display, the touch panel is directly attached on the display panel. This assembling method is simple but the touch display panel is thick and the display transmittance is not satisfactory. To overcome the defects, a technique of embedding an optical sensor array in a pixel array structure of an LCD is provided. The embedded in optical sensor when illuminated and not illuminated respectively outputs a different photoelectric signal. Therefore, it may be known if the touch event occurs by interpreting the photoelectric signal output by the optical sensor array.

FIG. 1 is a schematic view illustrating an optical touch display panel 100 according to a prior art. Referring to FIG. 1, the optical touch display panel 100 may include a data line D1, scan lines G1 and G2, a readout line RO1, and a pixel unit 102. A thin film transistor (TFT) T in the pixel unit 102 is conducted when the scan signal received by the scan line G1 is enabled, a liquid crystal capacitor C_{LC} and a storage capacitor C_{ST} are driven by a data signal from the data line D1. In addition, in the pixel unit 102, a gate of a switching transistor Q1 is coupled to the scan line G1, a source of the switching transistor Q1 is coupled to the readout line RO1, a drain of the switching transistor Q1 is coupled to the source of a photosensing transistor M1, and the gate and the drain of the photosensing transistor M1 are coupled to a common voltage Vcom applied to the pixel circuit 102.

When the switching transistor Q1 is conducted in response to a scan signal received by the scan line G1, the photoelectric signal SC generated by the photosensing transistor M1 is conducted out via the readout line RO1. When a light intensity varies (i.e. whether fingers or other media shield the photosensing transistor M1), the photoelectric signal SC generated by the photosensing transistor M1 changes. In this manner, by interpreting the photoelectric signal SC generated by the photosensing transistor M1, it is known if the touch event occurs in the area corresponding to the photosensing transistor M1. However, as the photosensing transistor M1 persistently suffers a bias of the common voltage Vcom, a threshold voltage (Vth) of the photosensing transistor M1 may exhibit a shift phenomenon. In this manner, the photoelectric signal SC generated by the photosensing transistor M1 is attenuated, which further influences the correctness of determining the touch position.

FIG. 2 is a schematic view illustrating an optical touch display panel 200 according to another prior art. Referring to FIG. 2, compared with FIG. 1, the gate and the drain of the photosensing transistor M1 of the optical touch display panel 200 are both coupled to the scan line G1. The voltage (Vgh) of the scan signal received by the scan line G1 is usually higher than the common voltage Vcom, therefore, a conductive passage (or referred to as a conduction degree) of the switching transistor Q1 and the photosensing transistor M1 is increased, so the strength of the photoelectric signal SC output by the photosensing transistor M1 via the readout line RO1 may also be enhanced. In this manner, the process of interpreting the photoelectric signal SC generated by the photosensing transistor M1 is carried out easily.

However, as the bias of the photosensing transistor M1 is the scan signal received by the scan line G1. Therefore, when the ambient light is bright, the voltage of the scan signal received by the scan line G1 becomes low (which is used for providing the bias of the photosensing transistor M1), and thus the conduction degree of the switching transistor Q1 is reduced, which limits the flow out of the photoelectric signal SC. Obviously, in the situation that the ambient light is bright, the voltage level of the photoelectric signal SC becomes low, and when the ambient light is dim, the voltage level of the photoelectric signal SC becomes high. This manner is in contrast to the common method for interpreting the optical touch. In addition, the voltage of the scan signal received by the scan line G1 becomes low, which also makes the charging capability of the pixel circuit 102 attenuated and further influences the image display quality.

In more details, when applied in a light stylus touch mode, the photoelectric signal SC at the position where the light spot is irradiated on will become small as the conduction degree of the switching transistor Q1 is small. A shadow caused by the handheld light stylus makes the strength of the photoelectric signal SC in the shadow enhanced, which causes the problem in determining the touch position and generates the ghost point. On the other hand, if applied in the shadow mode, the signal difference generated at the touch position becomes more unnoticeable, as the photoelectricity of the touch point is reduced in theory but is enlarged when the conduction degree of the switching transistor Q1 increases, which causes the phenomenon that the strength of the photoelectric signal SC at the touched light shielding position is increased.

### SUMMARY OF THE INVENTION

The present invention provides an optical touch display panel and a touch sensing method thereof, which may improve a correctness of interpreting a touch position.

The present invention provides an optical touch display panel, which includes a first scan line, a readout line and a photosensing unit. The photosensing unit is coupled to the first scan line and the readout line, is activated in response to a first scan signal received by the first scan line, and reacts a photosensing current on the readout line according to the first scan signal and a reference level.

In an embodiment of the present invention, the photosensing unit includes a switching transistor and a photosensing transistor. A gate of the switching transistor is coupled to the first scan line and a first source/drain is coupled to the readout line. A gate of the photo sensing transistor is coupled to the first scan line, a first source/drain is coupled to a second source/drain of the switching transistor, and a second source/drain receives the reference level.

In an embodiment of the present invention, the optical touch display panel further includes a pixel unit corresponding to the photosensing unit, and the photosensing unit is embedded in the pixel unit.

In an embodiment of the present invention, the reference level is a common voltage applied to the pixel unit.

In an embodiment of the present invention, the optical touch display panel further includes a black matrix located on the photosensing transistor, and the black matrix located on the photosensing transistor has no holes.

In an embodiment of the present invention, the optical touch display panel further includes a second scan line coupled to the second source/drain of the photosensing transistor, and the reference level is a disable level of a second scan signal received by the second scan line.

In an embodiment of the present invention, the optical touch display panel further includes a black matrix located on the photosensing transistor, and the black matrix located on the photosensing transistor has a corresponding hole.

The present invention also provides a touch sensing method of an optical touch display panel, which includes the following steps. A photosensing unit is embedded in a pixel unit of the optical touch display panel, in which the photosensing unit is coupled to a first scan line and a readout line of the optical touch display panel. The photosensing unit is activated in response to a first scan signal received by the first scan line, and reacts a photosensing current on the readout line according to the first scan signal and a reference level. The photosensing current is interpreted to acquire if a touch event occurs.

In an embodiment of the present invention, the reference level is a common voltage applied to the pixel unit.

In an embodiment of the present invention, the photosensing unit is further coupled to a second scan line of the optical touch display panel, and the reference level is a disable level of a second scan signal received by the second scan line.

In view of the above, the present invention activates the photosensing unit by a first scan signal received by the first scan line and reacts a photosensing current on the readout line according to the first scan signal and a reference level. In this manner, the threshold voltage of the photosensing transistor will not be influenced by the bias for a long time and generate the shift. As the voltage corresponding to the first scan signal is greater than the common voltage, the strength of the photosensing current output by the photosensing unit is enhanced, which further enhances the correctness of interpreting the photosensing current by the interpret unit.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 and FIG. 2 illustrate an optical touch display panel according to the prior arts;

FIG. 3 is a schematic view illustrating an electronic device according to an embodiment of the present invention;

FIG. 4 is a schematic view illustrating an optical touch display panel according to another embodiment of the present invention;

FIG. 5 and FIG. 6 are schematic views illustrating a structure of an optical touch display panel according to an embodiment of the present invention;

FIG. 7 is a schematic view illustrating an optical touch display panel according to another embodiment of the present invention; and

FIG. 8 is a schematic view illustrating a touch sensing method of an optical touch display panel according to an embodiment of the present invention.

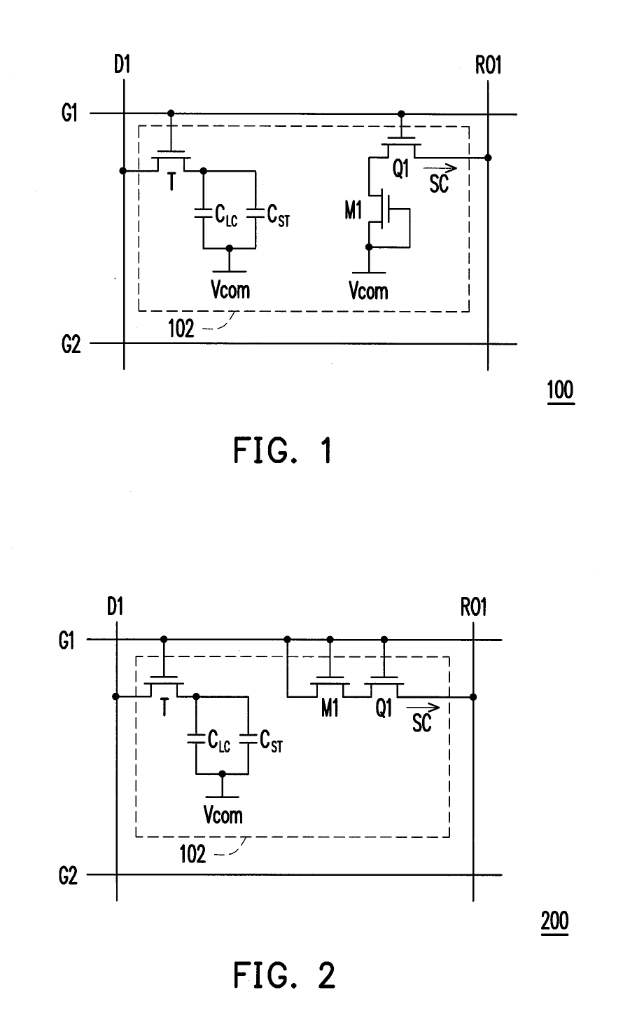

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

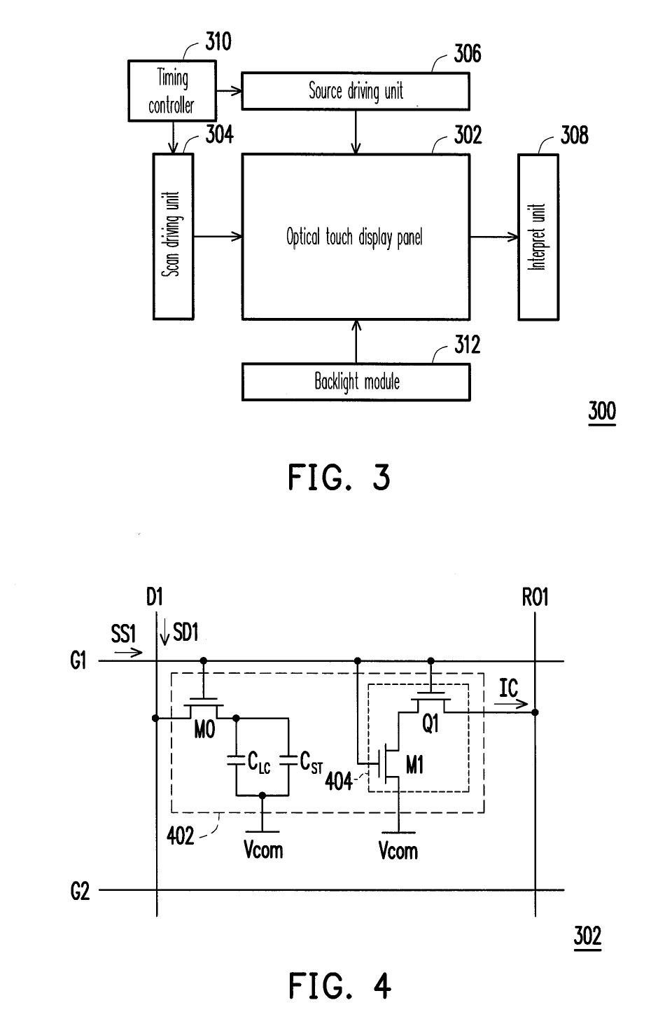

FIG. 3 is a schematic view illustrating an electronic device 300 according to an embodiment of the present invention. Referring to FIG. 3, the electronic device 300 may be a smart phone, a flat panel computer, a laptop computer and the like having the touch function, however, the present invention is not limited thereto. The electronic device 300 includes an optical touch display panel 302, a scan driving unit 304, a source driving unit 306, an interpret unit 308, a timing controller 310 and a backlight module 312. The backlight module 312 provides a (back)light source required by the optical touch display panel 302. In addition, the scan driving unit 304 and the source driving unit 306 are controlled by the timing controller 310, for respectively generating a scan signal and a data signal to drive the display pixels in the optical touch display panel 302, thereby making the optical touch display panel 302 display the images.

FIG. 4 is a schematic view illustrating a part of the optical touch display panel 302 according to an embodiment of the present invention. Referring to FIG. 3 and FIG. 4 together, the optical touch display panel 302 includes scan lines G1 and G2, a data line D1, a readout line RO1 and a pixel unit 402. The pixel unit 402 includes a photosensing unit 404 embedded in the pixel unit 402 and a display pixel constituted by a TFT M0, a liquid crystal capacitor C_{LC} and a storage capacitor C_{ST}.

In this embodiment, when the scan line G1 receives the scan signal SS1 from the scan driving unit 304, the TFT M0 is conducted and the liquid crystal capacitor C_{LC} and storage capacitor C_{ST} are driven by the data signal SD1 from the source driving unit 306. In addition, the photosensing unit 404 is coupled to the scan line G1 and the readout line RO1, and is activated in response to the scan signal SS1 received by the scan line G1 and reacts a photosensing current IC on the readout line RO1 according to the scan signal SS1 and the reference level (for example, the common voltage Vcom applied to the pixel unit 402). In this manner, the interpret unit 308 may acquire if the touch event occurs just by interpreting the photosensing current IC.

In more details, the photosensing unit 404 includes a switching transistor Q1 and a photosensing transistor M1. A gate of the switching transistor Q1 is coupled to the scan line G1, a first source/drain of the switching transistor Q1 is coupled to the readout line RO1 and a second source/drain of the switching transistor Q1 is coupled to a first source/drain of the photosensing transistor M1. In addition, a gate of the photosensing transistor M1 is coupled to the scan line G1, and a second source/drain of the photosensing transistor M1 is coupled to the common voltage Vcom. The photosensing transistor M1 generates the photosensing current IC accordingly in response to the changes of the light intensity of the optical touch display panel 200.

When the scan signal SS1 is enabled, in addition to that the TFT M0 is conducted to implement the pixel writing, the switching transistor Q1 and the photosensing transistor M1 may be conducted at the same time to implement the touch sensing. At the same time, as the photosensing transistor M1 is biased by the common voltage Vcom, the photosensing transistor M1 outputs the generated photosensing current IC to the readout line RO1 via the switching transistor Q1, thereby providing for the interpret unit 204 to interpret and acquire if the touch event occurs.

Obviously, as the photosensing transistor M1 is conducted only when the scan signal SS1 is enabled, a threshold voltage (Vth) of the photosensing transistor M1 is not influenced by the bias for a long time to generate the shift. In addition, as the corresponding voltage (Vgh) when the scan signal SS1 is enabled usually is greater than the common voltage Vcom, the conduction degree of the switching transistor Q1 and the photosensing transistor M1 is increased, and further the strength of the photosensing current IC output by the photosensing transistor M1 via the readout line RO1 may be enhanced. In this manner, the interpret unit 308 may interpret the photosensing current IC generated by the photosensing transistor M1 easily and accurately.

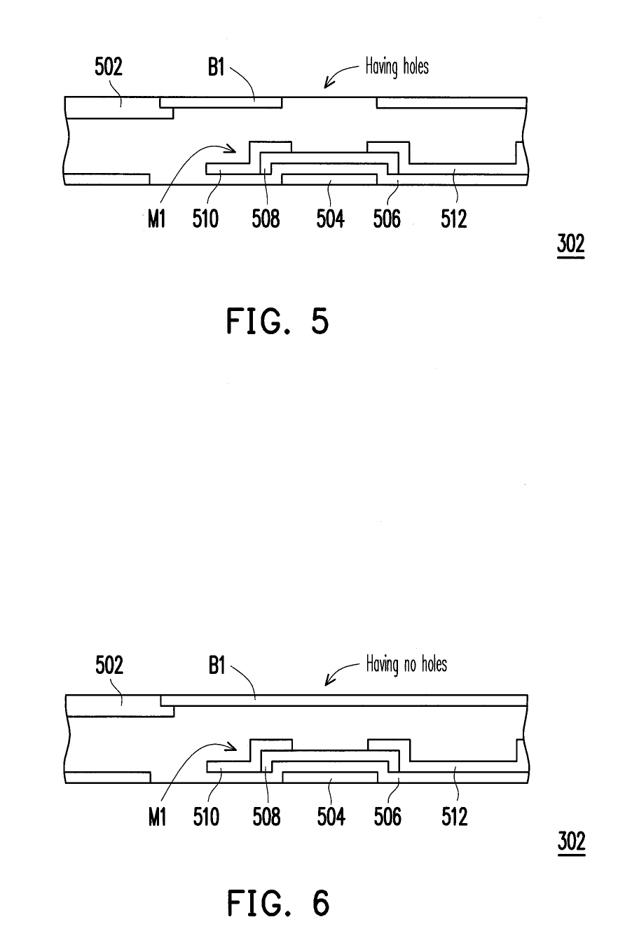

It should be noted that FIG. 5 is a schematic view illustrating a part of the optical touch display panel 100 according to an embodiment of the present invention. Referring to FIG. 5, the optical touch display panel 100 includes a color filter layer 502, a black matrix B1 and a photosensing transistor M1. The black matrix B1 is located on the photosensing transistor M1. The photosensing transistor M1 includes a gate metal layer 504, a gate insulating layer 506, an amorphous silicon layer 508, a source layer 510 and a drain layer 512. The gate insulating layer 506 is located above the gate metal layer 504 and is located below the amorphous silicon layer 508. The source layer 510 and the drain layer 512 are located on two sides of the amorphous silicon layer 508 and cover a part of the amorphous silicon layer 508.

Accordingly, in the conventional structure, the black matrix B1 on the photosensing transistor M1 has a hole, and therefore, the photosensing transistor M1 may persistently in an illumination state. In addition, as the photosensing transistor M1 is biased by the common voltage Vcom to generate the photosensing current IC, when the optical touch display panel 302 is illuminated, the photosensing current of the photosensing transistor embedded in the optical touch display panel 302 (regardless whether it is conducted) may possibly influence the stability of the common voltage Vcom, thereby influencing the image display quality.

In view of the above, in the embodiment of FIG. 4, a novel structure (such as FIG. 6) may be used, the black matrix B1 on the photosensing transistor M1 does not have any hole. In this manner, as the photosensing transistor M1 is not persistently illuminated (ambient/environment), the photosensing current IC generated by the photosensing transistor M1 is greatly reduced. When the fingers or other media shield/touch the optical touch display panel 302, the (back)light source from the backlight module 312 is projected to the fingers or other media and then scattered to the photosensing transistor M1 to change the photosensing current IC generated by the photosensing transistor M1. Therefore, the touch sensing may be implemented without influencing the stability of the common voltage Vcom.

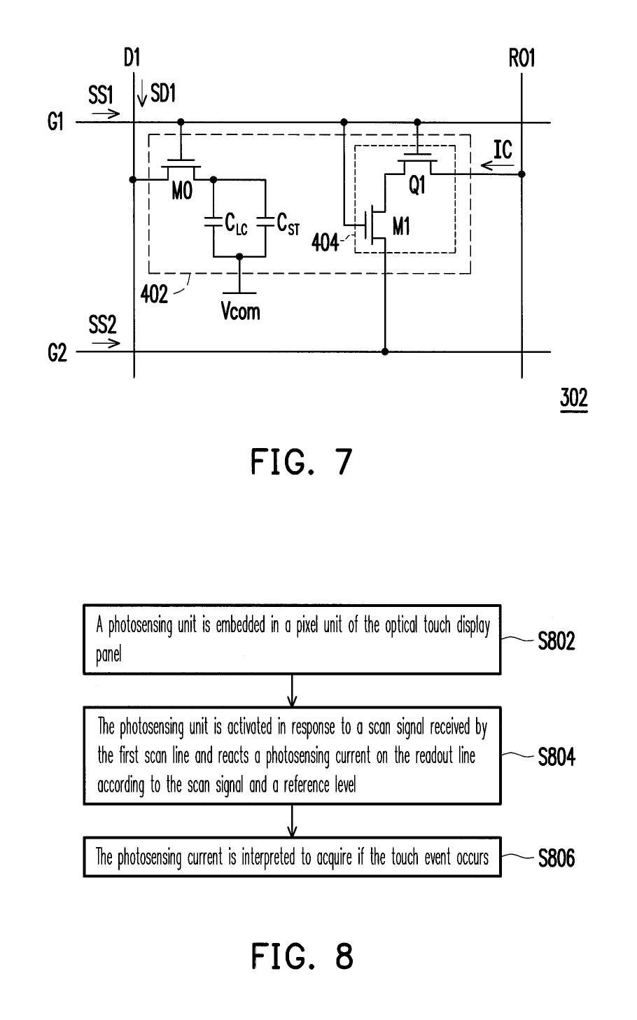

On the other hand, in other embodiments of the present invention, the embodiment of FIG. 4 may be further modified. In more details, as shown in FIG. 7, the second source/drain of the photosensing transistor M1 is coupled to the scan line G2. In this manner, the photosensing unit 404 is activated in response to the scan signal SS1 received by the scan line G1 and reacts a photosensing current IC on the readout line RO1 according to the scan signal SS1 and the reference level (for example, a disable level of the scan signal SS2 received by the scan line G2). In this manner, the interpret unit 308 may acquire if the touch event occurs just by interpreting the photosensing current IC.

Likewise, when the scan signal SS1 is enabled, besides the TFT M0 is conducted to implement the pixel writing, the switching transistor Q1 and the photosensing transistor M1 may be conducted at the same time to implement the touch sensing. At this time, as the second source/drain of the photosensing transistor M1 is coupled to the scan line G2 (i.e. the scan signal SS2 received by the scan line G2 is disabled), as compared with the embodiment of FIG. 4, the gate/source voltage (Vgs) and the drain/source voltage (Vds) of the photosensing transistor M1 of the embodiment of FIG. 7 are relatively large (which can increase the photosensing current IC), and the photosensing current IC reacted on the readout line RO1 is provided by the interpret unit 308 instead to flow to the scan line G2 sequentially via the readout line RO1, the switching transistor Q1 and the photosensing transistor M1. In this manner, the effect of pre-charging the display pixel on the scan line G2 may be realized.

It is worthy of mentioning that the embodiment of FIG. 7 may adopt the fabricating structure in FIG. 5 or FIG. 6, the photosensing current strength when the fabricating structure (i.e. having holes) of FIG. 5 is adopted is greater than that of FIG. 6, so the photosensing current when the fabricating substrate (i.e. having holes) of FIG. 5 is adopted has a higher pre-charging effect on the scan line G2 as compared with FIG. 6.

In view of the content disclosed/taught in the above embodiments, at least a touch sensing method of an optical touch display panel is illustrated.

FIG. 8 is a flow chart illustrating processes of a touch sensing method of an optical touch display panel according to an embodiment of the present invention. Referring to FIG. 8, the touch sensing method of the optical touch display panel may include the following steps.

A photosensing unit is embedded in a pixel unit of the optical touch display panel (step S802). The photosensing unit is coupled to a first scan line and a readout line of the optical touch display panel.

The photosensing unit is activated in response to a scan signal received by the first scan line and reacts a photosensing current on the readout line according to the scan signal and a reference level (step S804), in which the reference level may be a common voltage applied to the pixel unit or is a disable level of a scan signal received by a second scan line adjacent to the first scan line.

The photosensing current is interpreted to acquire if the touch event occurs (step S806).

In view of the above, the embodiments of the present invention activate the photosensing unit by the first scan signal received by the first scan line so as to react a photosensing current on the readout line according to the first scan signal and a reference level. In this manner, the threshold voltage of the photosensing transistor will not be influenced by the bias for a long time to generate the shift. As the voltage corresponding to the first scan signal is greater than the common voltage, the strength of the photosensing current output by the photosensing unit is enhanced, which further enhances the correctness of interpreting the photosensing current by the interpret unit. In addition, the photosensing unit may be coupled to the next adjacent scan line, and thus the interpret unit may provide the photosensing current to the next adjacent scan line, so as to pre-charge the display pixel thereon. Furthermore, the photosensing transistor may be further disposed below the black matrix having no holes, thereby preventing the display quality of the optical touch display panel from being influenced by the photoelectricity generated by the ambient light.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An optical touch display panel, comprising:
a first scan line;
a readout line; and
a photosensing unit, coupled to the first scan line and the readout line, activated in response to a first scan signal received by the first scan line, and reacting a photo sensing current on the readout line according to the first scan signal and a reference level.

2. The optical touch display panel according to claim 1, wherein the photosensing unit comprises:
a switching transistor, having a gate coupled to the first scan line and a first source/drain coupled to the readout line; and
a photosensing transistor, having a gate coupled to the first scan line, a first source/drain coupled to a second source/drain of the switching transistor and a second source/drain for receiving the reference level.

3. The optical touch display panel according to claim 2, further comprising:
a pixel unit, corresponding to the photosensing unit, wherein the photosensing unit is embedded in the pixel unit.

4. The optical touch display panel according to claim 3, wherein the reference level is a common voltage applied to the pixel unit.

5. The optical touch display panel according to claim 4, further comprising:
a black matrix, located on the photosensing transistor, wherein the black matrix located on the photosensing transistor has no holes.

6. The optical touch display panel according to claim 3, further comprising:
a second scan line, coupled to the second source/drain of the photosensing transistor, wherein the reference level is a disable level of a second scan signal received by the second scan line.

7. The optical touch display panel according to claim 6, further comprising:
a black matrix, located on the photosensing transistor, wherein the black matrix located on the photosensing transistor has a corresponding hole.

8. A touch sensing method of an optical touch display panel, comprising:
providing a photosensing unit embedded in a pixel unit of the optical touch display panel, wherein the photosensing unit is coupled to a first scan line and a readout line of the optical touch display panel;
activating the photosensing unit in response to a first scan signal received by the first scan line and reacting a photosensing current on the readout line according to the first scan signal and a reference level; and
interpreting the photosensing current to acquire if a touch event occurs.

9. The touch sensing method of the optical touch display panel according to claim 8, wherein the reference level is a common voltage applied to the pixel unit.

10. The touch sensing method of the optical touch display panel according to claim 8, wherein the photosensing unit is further coupled to a second scan line of the optical touch display panel, and the reference level is a disable level of a second scan signal received by the second scan line.
